(19) United States
(12) Patent Application Publication
(10) Pub. No.: US 2024/0236296 A9
(43) Pub. Date: Jul. 11, 2024

(54) Method for determining an image coding mode

(71) Applicant: ORANGE, Issy-les-Moulineaux (FR)

(72) Inventors: Pierrick Philippe, CHATILLON CEDEX (FR); Théo Ladune, CHATILLON CEDEX (FR)

(21) Appl. No.: 18/546,859

(22) PCT Filed: Feb. 15, 2022
(86) PCT No.: PCT/FR2022/050274

§ 371 Date: Aug. 17, 2023

(30) Foreign Application Priority Data
Feb. 19, 2021 (FR) 2101633

(51) Int. Cl. H04N 19/103; H04N 19/182

(52) U.S. Cl. CPC H04N 19/103; H04N 19/182

(57) ABSTRACT

A method for determining at least one coding or decoding mode, from at least two coding or decoding modes, in order to encode or decode at least one current set of pixels. The at least one coding or decoding mode is determined from an analysis of at least one set of reference pixels.

### FIELD OF THE INVENTION

The present invention relates in general to the field of image processing, and more specifically to the coding and the decoding of digital images and of sequences of digital images.

The coding/decoding of digital images applies in particular to images from at least one video sequence comprising:
images from one and the same camera and in temporal succession (2D coding/decoding),
images from various cameras oriented with different views (3D coding/decoding),
corresponding texture and depth components (3D coding/decoding),
etc.

The present invention applies similarly to the coding/decoding of 2D or 3D images. The invention may in particular, but not exclusively, be applied to the video coding implemented in current AVC, HEVC and VVC video encoders and their extensions (MVC, 3D-AVC, MV-HEVC, 3D-HEVC, etc.), and to the corresponding decoding.

### PRIOR ART

Current video encoders (MPEG, AVC, HEVC, VVC, AV1, etc.) use a blockwise representation of the video sequence. The images are split up into blocks, which are able to be split up again recursively. Each block is then coded using a particular coding mode, for example an Intra, Inter, Skip, Merge, etc. mode. Some images are coded without reference to other past or future images, using a coding mode such as for example the Intra coding mode, the IBC (for “Intra Block Copy”) coding mode.

Other images are coded with respect to one or more coded-decoded reference images, using motion compensation, which is well known to those skilled in the art. This temporal coding mode is called Inter coding mode.

A residual block, also called a prediction residual, corresponding to the original block decreased by a prediction, is coded for each block. In the case of a Skip coding mode, the residual block is zero.

For a block under consideration to be coded, multiple Intra, Inter, Skip, Merge, etc. coding modes for this block are put into competition at the encoder, with the aim of selecting the best coding mode, that is to say the one that optimizes the coding of the block under consideration according to a predetermined coding performance criterion, for example the data rate/distortion cost, that is to say the comparison of a measure of the distortion between the original image and the image coded and then decoded by the decoder, and the data rate necessary to transmit the decoding instructions, or even an efficiency/complexity compromise, which are criteria well known to those skilled in the art. The encoder is responsible for sending, to the decoder, the coding information relating to the optimum coding mode so as to enable the decoder to reconstruct the original block. Such information is transmitted in a stream, typically in the form of a binary representation.

The more precise the chosen coding mode, for example in terms of pixel-to-pixel position, the lower the data rate of the residual will be. On the other hand, it will require more information to be transmitted, in particular at the contours of a shape.

The decoding is carried out at the decoder based on the coding information read from the stream and then decoded, and also based on elements already available at the decoder, that is to say decoded beforehand.

These elements that are already available are in particular:
elements of the image currently being decoded: reference is then made to Intra or IBC decoding mode, for example,
elements from other previously decoded images: reference is then made to Inter decoding mode.

These two types of Intra and Inter coding modes may be combined, in accordance with the VVC standard (for “Versatile Video Coding”). Reference is made to CIIP (for “Combined Inter and Intra Prediction”).

According to these prediction techniques, the encoder has to signal the optimum mode type to be executed to the decoder. This information is conveyed for each block. It may lead to a large amount of information to be inserted into the stream, and should be minimized in order to limit the data rate. As a result, it may lack precision, in particular for highly textured images containing a lot of detail.

This lack of precision results in a limitation of the quality of the reconstructed image for a given data rate.

### AIM AND SUMMARY OF THE INVENTION

One of the aims of the invention is to rectify the drawbacks of the abovementioned prior art by improving the determination of the coding modes from the prior art, in favor of reducing the cost of signaling information related to the coding mode determined for the coding of a current set of pixels.

To this end, one subject of the present invention relates to a method for determining at least one coding mode, respectively decoding mode, from among at least two coding modes, respectively decoding modes, for coding, respectively decoding, at least one current set of pixels. Such a determination method is characterized in that said at least one coding mode, respectively decoding mode, is determined based on analysis of at least one reference set of pixels.

Such a method for determining at least one coding mode (respectively decoding mode) according to the invention advantageously makes it possible to rely only on one or more reference sets of pixels, in other words one or more sets of pixels already decoded at the time of coding or decoding of the current set of pixels, in order to determine, from among at least two possible coding modes (respectively decoding modes), the one and/or more coding modes (respectively decoding modes) to be applied to each pixel of the current set of pixels. Since this or these reference sets of pixels are available at the time of coding (respectively decoding) of the current set of pixels, the precision of this/these reference sets of pixels is perfectly known for each pixel position, unlike an encoder (respectively decoder) that operates in a blockwise manner in the prior art. The determination of the one or more coding (respectively decoding) modes to be applied to each pixel of the current set of pixels is thereby improved, since it is more direct and spatially precise than that implemented in the prior art, which is based on computing a coding performance criterion per block.

The coding (respectively decoding) mode to be applied to the current set of pixels is thus more precise and adapts better to the local properties of the image.

This results in an improved quality of the reconstructed image.

According to one particular embodiment, a single coding mode, respectively decoding mode, from among the at least two modes is determined for at least one pixel of the current set of pixels, the determination of one or the other mode varying from said at least one pixel to at least one other pixel of said set.

Such an embodiment advantageously makes it possible to reuse coding or decoding modes from the prior art (for example intra, skip, inter, etc.) with pixel precision.

According to another particular embodiment, the at least two coding modes, respectively decoding modes, are determined in combination for at least one pixel of the current set of pixels.

Such an embodiment advantageously makes it possible to be able to combine at least two coding modes (skip, intra, inter, etc.), respectively decoding modes, in order to code, respectively decode, one and the same pixel. This embodiment also makes it possible to be able to change gradually from one coding mode, respectively decoding mode, to the other without generating discontinuities comparable to block effects.

According to yet another particular embodiment, the determination of said at least one coding mode, respectively decoding mode, is modified by a modification parameter that results from analysis of the current set of pixels.

Such an embodiment advantageously makes it possible to apply a correction to the determination of said at least one coding or decoding mode when the current set of pixels contains an element that was not present/predictable in the one or more reference sets of pixels.

The various abovementioned embodiments or implementation features may be added, independently or in combination with one another, to the determination method defined above.

The invention also relates to a device for determining at least one coding mode, respectively decoding mode, comprising a processor that is configured to determine at least one coding mode, respectively decoding mode, from among at least two coding modes, respectively decoding modes, for encoding, respectively decoding, at least one current set of pixels.

Such a determination device is characterized in that said at least one coding mode, respectively decoding mode, is determined based on analysis of at least one reference set of pixels.

In one particular embodiment, the determination device is a neural network.

The use of a neural network advantageously makes it possible to optimize the precision of the determination of said at least one coding mode, respectively decoding mode.

Such a determination device is in particular able to implement the abovementioned determination method.

The invention also relates to a method for coding at least one current set of pixels, implemented by a coding device, wherein the current set of pixels is coded based on a determination of at least one coding mode.

Such a coding method is characterized in that said at least one coding mode is determined in accordance with the abovementioned determination method according to the invention.

Such a coding method is advantageous in that it does not require the coding of one or more indices indicating the one and/or more coding modes used to code the current set of pixels. This means that this or these mode indices do not need to be transmitted by the encoder to a decoder for the current set of pixels, thereby making it possible to reduce the cost of signaling the information transmitted between the encoder and the decoder in favor of better quality of reconstruction of the image, related to the finer selection of the coding modes.

The invention also relates to a coding device or encoder for coding at least one current set of pixels, comprising a processor that is configured to code the current set of pixels based on a determination of at least one coding mode.

Such a coding device is characterized in that it comprises an abovementioned device for determining at least one coding mode according to the invention.

Such a coding device is in particular able to implement the abovementioned coding method according to the invention.

The invention also relates to a method for decoding at least one current set of pixels, implemented by a decoding device, wherein the current set of pixels is decoded based on a determination of at least one decoding mode.

Such a decoding method is characterized in that said at least one decoding mode is determined in accordance with the abovementioned determination method according to the invention.

The advantage of such a decoding method lies in the fact that the determination of at least one decoding mode for decoding the current set of pixels is implemented autonomously by the decoder based on one or more available reference sets of pixels, without the decoder needing to read specific information from the data signal received from the encoder.

The invention also relates to a decoding device or decoder for decoding at least one current set of pixels, comprising a processor that is configured to decode the current set of pixels based on a determination of at least one decoding mode.

Such a decoding device is characterized in that it comprises an abovementioned device for determining at least one decoding mode according to the invention.

Such a decoding device is in particular able to implement the abovementioned decoding method according to the invention.

The invention also relates to a computer program comprising instructions for implementing the determination method according to the invention and also the coding or decoding method integrating the determination method according to the invention, according to any one of the particular embodiments described above, when said program is executed by a processor.

Such instructions may be permanently stored in a non-transitory memory medium of the determination device implementing the abovementioned determination method, of the encoder implementing the abovementioned coding method, of the decoder implementing the abovementioned decoding method.

This program may use any programming language and be in the form of source code, object code or intermediate code between source code and object code, such as in a partially compiled form, or in any other desirable form.

The invention also targets a computer-readable recording medium or information medium comprising instructions of a computer program as mentioned above.

The recording medium may be any entity or device capable of storing the program.

For example, the medium may comprise a storage means, such as a ROM, for example a CD-ROM, a DVD-ROM, a synthetic DNA (deoxyribonucleic acid), etc., or a microelectronic circuit ROM, or else a magnetic recording means, for example a USB key or a hard disk.

Moreover, the recording medium may be a transmissible medium such as an electrical or optical signal, which may be conveyed via an electrical or optical cable, by radio or by other means. The program according to the invention may in particular be downloaded from a network such as the Internet.

Alternatively, the recording medium may be an integrated circuit in which the program is incorporated, the circuit being designed to execute or to be used in the execution of the abovementioned determination method, coding method or decoding method according to the invention.

### BRIEF DESCRIPTION OF THE DRAWINGS

Other features and advantages will become apparent from reading particular embodiments of the invention, which are given by way of illustrative and non-limiting examples, and the appended drawings, in which:

FIG. 1 shows the main steps of a method for determining at least one coding or decoding mode in accordance with the invention,

FIG. 2A shows one type of reference set of pixels analyzed in the determination method of FIG. 1, in a first particular embodiment of the invention,

FIG. 2B shows another type of reference set of pixels analyzed in the determination method of FIG. 1, in a second particular embodiment of the invention,

FIG. 3A shows a determination device implementing the determination method of FIG. 1, in a first embodiment,

FIG. 3B shows a determination device implementing the determination method of FIG. 1, in a second embodiment,

FIG. 4 schematically shows a method for training the determination device of FIG. 3B,

FIG. 5A shows a first exemplary displacement of a predicted version of a current set of pixels with respect to two reference sets of pixels,

FIG. 5B shows a second exemplary displacement of a predicted version of a current set of pixels with respect to two reference sets of pixels,

FIG. 5C shows a third exemplary displacement of a predicted version of a current set of pixels with respect to two reference sets of pixels,

FIG. 5D shows motion compensation implemented in the case of the type of displacement of FIG. 5A, in one particular embodiment of the invention,

FIG. 5E shows determination of at least one coding mode, respectively decoding mode, implemented at the end of the motion compensation of FIG. 5D, in one particular embodiment of the invention,

FIG. 6 shows, in more detail, certain steps of the determination method implemented by the determination device of FIG. 3A,

FIG. 7 shows the main steps of an image coding method implementing the method for determining at least one coding mode of FIG. 1, in one particular embodiment of the invention,

FIG. 8A shows an encoder implementing the coding method of FIG. 7, in a first embodiment,

FIG. 8B shows an encoder implementing the coding method of FIG. 7, in a second embodiment,

FIG. 9 shows the main steps of an image decoding method implementing the method for determining at least one decoding mode of FIG. 1, in one particular embodiment of the invention,

FIG. 10A shows a decoder implementing the decoding method of FIG. 9, in a first embodiment,

FIG. 10B shows a decoder implementing the decoding method of FIG. 9, in a second embodiment,

FIG. 11 shows the steps of an image coding method implementing a modification of the method for determining a coding mode of FIG. 1, in one particular embodiment of the invention,

FIG. 12 shows an encoder implementing the coding method of FIG. 11, in one particular embodiment of the invention,

FIG. 13 shows the steps of an image decoding method implementing a modification of the method for determining a decoding mode of FIG. 1, in one particular embodiment of the invention,

FIG. 14 shows a decoder implementing the decoding method of FIG. 13, in one particular embodiment of the invention.

### DETAILED DESCRIPTION OF VARIOUS EMBODIMENTS OF THE INVENTION

Exemplary Implementations of a Method for Determining at Least One Coding or Decoding Mode

General Principle of the Invention

Method for Determining at Least One Coding or Decoding Mode

A description is given below of a method for determining at least one coding or decoding mode with a view to coding, respectively decoding, a 2D or 3D image, said determination method being able to be implemented in any type of video encoders or decoders, for example compliant with the AVC, HEVC, VVC standard and their extensions (MVC, 3D-AVC, MV-HEVC, 3D-HEVC, etc.), or the like, such as for example a convolutional neural network (or CNN).

With reference to FIG. 1, the method for determining at least one coding or decoding mode according to the invention uses at least one reference set of pixels BR₀, that is to say a reference set of pixels that has already been coded and decoded and that is therefore available at the time of determining said at least one coding or decoding mode intended to be used to code, respectively decode, a current set of pixels B_{c} that comprises N pixels p₁, p₂, . . . , p_{N} (N≥1).

Within the meaning of the invention, a current set of pixels B_{c} is understood to mean:
an original current image;
a part or a region of the original current image,
a block of the current image resulting from partitioning of this image in line with what is carried out in standardized AVC, HEVC or VVC encoders.

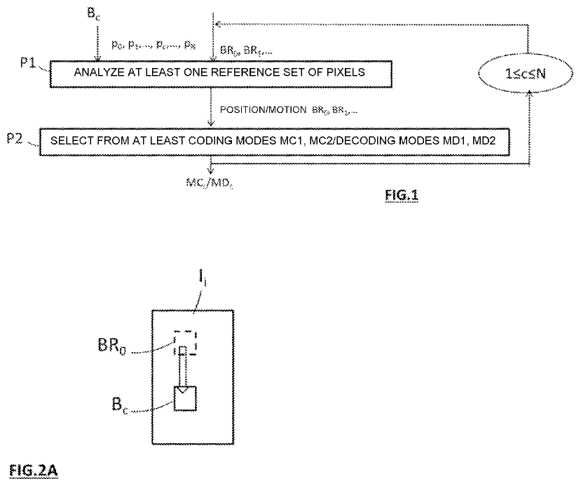

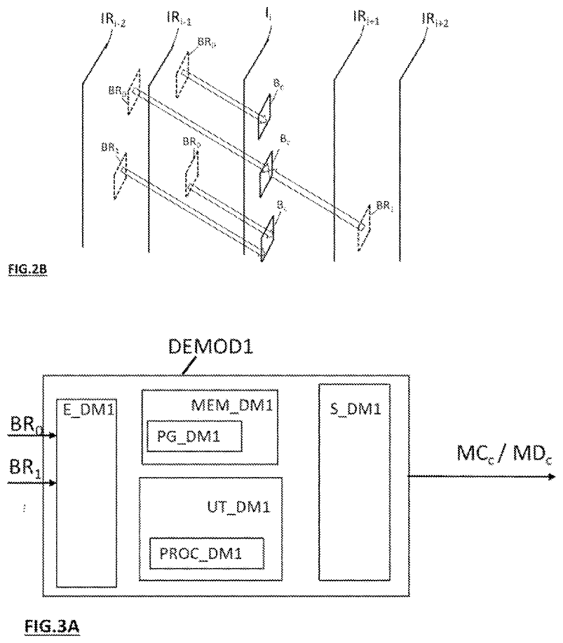

According to the invention, as shown in FIG. 2A, the reference set of pixels BR₀ may belong to a current image Iᵢ that contains the current set of pixels B_{c}. In this case, at least one coding mode MC_{c} (respectively decoding mode MD_{c}) for the current set of pixels B_{c} is determined with respect to this reference set of pixels BR₀. Of course, said at least one coding mode MC_{c} (respectively decoding mode MD_{c}) may be determined with respect to the reference set of pixels BR₀ and to one or more other reference sets of pixels belonging to the current image Iᵢ.

According to the invention, as shown in FIG. 2B, the reference set of pixels BR₀ may belong to an already coded and decoded reference image that precedes or follows the current image Iᵢ in time. In this case, the coding mode MC_{c} (respectively decoding mode MD_{c}) for the current set of pixels B_{c} is determined with respect to the reference set of pixels BR₀. In the example shown, the coding mode MC_{c} (respectively decoding mode MD_{c}) for the current set of pixels B_{c} may be computed with respect to the reference set of pixels BR₀, the reference set of pixels BR₀ belonging for example to the immediately preceding image but of course being able to belong to another reference image, such as for example the image IRᵢ₊₁ or other reference images preceding the current image Iᵢ in the coding order, that is to say images that have already been coded and then decoded before the current image Iᵢ. In the example shown, the coding mode MC_{c} (respectively decoding mode MD_{c}) for the current set of pixels B_{c} may also be computed with respect to the reference set of pixels BR₀ located in a reference image that precedes the current image Iᵢ and with respect to at least one other reference set of pixels BR₁ located in a reference image that follows the current image Iᵢ. In the example shown, the reference set of pixels BR₀ is located in the reference image IRᵢ₋₂ and the reference set of pixels BR₁ is located in the reference image IRᵢ₊₁. Still in the context of such determination of at least one coding or decoding mode with respect to reference sets of pixels located in reference images, and as shown in FIG. 2B, the coding mode MC_{c} (respectively decoding mode MD_{c}) for the current set of pixels B_{c} may be computed with respect to two reference sets of pixels BR₀, BR₁ each located in a reference image that precedes the current image Iᵢ. In the example shown, the reference set of pixels BR₀ is located in the reference image IRᵢ₋₂ and the reference set of pixels BR₁ is located in the reference image IRᵢ₋₁.

Of course, one or more other reference sets of pixels may be used together with the reference sets of pixels BR₀ and BR₁ to compute said at least one current coding mode MC_{c} (respectively decoding mode MD_{c}) for the current set of pixels B_{c}.

With reference again to FIG. 1, such a determination method according to the invention comprises the following:

In P1, for at least one current pixel p_{c} (1≤c≤N) of the current set of pixels B_{c}, said at least one reference set of pixels BR₀ is analyzed. Such a step comprises in particular analyzing the position of BR₀, its displacement from one reference image to another, whether occlusion regions are generated during the displacement of BR₀, etc.

In P2, based on the analysis of BR₀, a coding mode MC_{c}, respectively decoding mode MD_{c}, is selected from among at least two coding modes MC₁, MC₂, respectively decoding modes MD₁, MD₂, under consideration.

The mode MC₁, respectively MD₁, is for example the Inter mode. The mode MC₂, respectively MD₂, is for example the Intra mode. As an alternative, the mode MC₁, respectively MD₁, is for example the Inter mode and the mode MC₂, respectively MD₂, is for example the Skip mode.

At the end of step P2, a coding mode MC_{c}, respectively decoding mode MD_{c}, is determined for said at least one current pixel p_{c}.

Steps P1 to P2 are then iterated for each of the N pixels of the current set of pixels B_{c}.

Of course, more than two coding modes, respectively decoding modes, may be considered in the determination method that has just been described. For example, the following three encoding or decoding modes may be considered during the determination:
the mode MC₁/MD₁ is Inter,
the mode MC₂/MD₂ is Intra,
the mode MC₃/MD₃ is Skip.

As a variant of step P2, at least two coding/decoding modes may be determined in combination in order to code/decode said at least one current pixel p_{c}. For example, a combination of the modes MC₁/MD₁=Inter and MC₂/MD₂=Intra may be determined in order to code/decode B. According to another example, a combination of the modes MC₁/MD₁=Inter and MC₃/MD₃=Skip may be determined in order to code/decode B.

Exemplary Implementations of a Device for Determining at Least One Coding or Decoding Mode

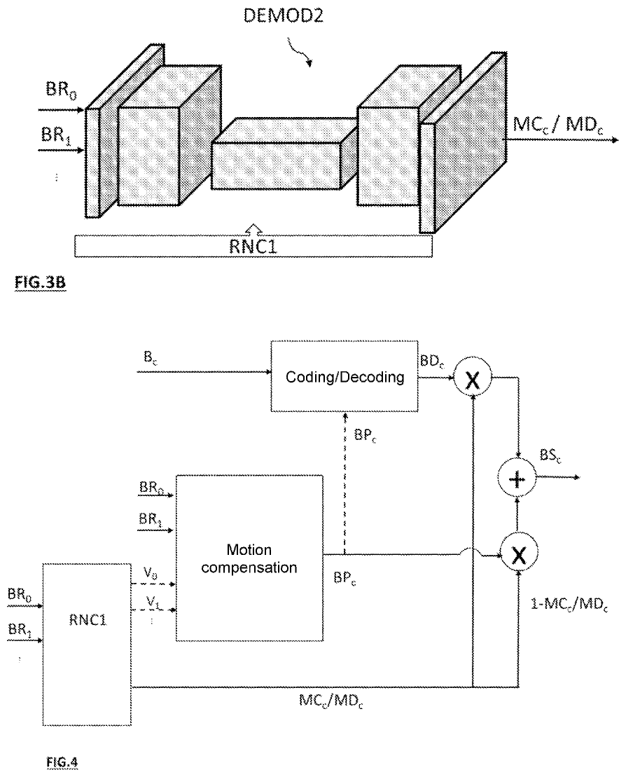

FIG. 3A shows a device DMOD1 for determining at least one coding or decoding mode suitable for implementing the determination method illustrated in FIG. 1, according to a first embodiment of the invention.

According to this first embodiment, the actions performed by the determination method are implemented by computer program instructions. To that end, the prediction device DMOD1 has the conventional architecture of a computer and comprises in particular a memory MEM_DM1, a processing unit UT_DM1, equipped for example with a processor PROC_DM1, and driven by the computer program PG_DM1 stored in memory MEM_DM1. The computer program PG_DM1 comprises instructions for implementing the actions of the determination method as described above when the program is executed by the processor PROC_DM1.

On initialization, the code instructions of the computer program PG_DM1 are for example loaded into a RAM memory (not shown) before being executed by the processor PROC_DM1. The processor PROC_DM1 of the processing unit UT_DM1 implements in particular the actions of the determination method described above, according to the instructions of the computer program PG_DM1.

The determination device receives, at input E_DM1, one or more reference sets of pixels BR₀, BR₁, etc., evaluates various available coding modes MC₁, MC₂, respectively decoding modes MD₁, MD₂, and delivers, at output S_DM1, the coding mode MC_{c} or decoding mode MD_{c} to be used to respectively code or decode the current set of pixels B_{c}.

FIG. 3B shows a device DMOD2 for determining at least one coding or decoding mode suitable for implementing the determination method illustrated in FIG. 1, according to a second embodiment of the invention.

According to this second embodiment, the determination device DMOD2 is a neural network, such as for example a convolutional neural network, a multilayer perceptron, an LSTM (for “Long Short Term Memory”), etc., denoted RNC1, which, from one or more reference sets of pixels BR₀, BR₁, etc. received at input, jointly implements steps P1 to P2 of the determination method of FIG. 1 in order to deliver, at output, the coding mode MC_{c} or decoding mode MD_{c} for each pixel of the current set of pixels B_{c}.

In a manner known per se, the convolutional neural network RNC1 carries out a succession of layers of filtering, non-linearity and scaling operations. Each filter that is used is parameterized by a convolution kernel, and non-linearities are parameterized (ReLU, leaky ReLU, GDN (“generalized divisive normalization”), etc.). The neural network RNC1 is for example of the type described in the document D. Sun, et al., “PWC-Net: CNNs for Optical Flow Using Pyramid, Warping, and Cost Volume” CVPR 2018.

In this case, the neural network RNC1 may be trained in the manner shown in FIG. 4.

To this end, the neural network RNC1 may be trained:
to possibly estimate one or more displacement vectors V₀, V₁, etc. in order to interpolate movements from respectively BR₀, BR₁, etc. to the current set of pixels B_{c} currently being coded or decoded, in order to obtain a prediction set of pixels BP_{c};
to estimate the coding mode MC_{c}, respectively decoding mode MD_{c}, from among at least two coding modes, respectively decoding modes.

The coding mode MC_{c}, respectively decoding mode MD_{c}, takes at least two values 0 or 1, which are for example representative respectively:

of the Inter mode and of the Skip mode,
of the Intra mode and of the Skip mode,
of the Inter mode and of the Intra mode,
etc.

In a preliminary phase, the network RNC1 is trained to carry out operations P1 to P2 from FIG. 1. For example, the network RNC1 is trained to minimize the root mean squared error between the current set of pixels B_{c} to be coded and a set of pixels BS_{c} obtained after applying at least one coding mode MC_{c} (respectively decoding mode MD_{c}) selected:
from the current prediction set of pixels BP_{c} obtained through motion compensation, equivalent to a Skip mode,
and the reconstructed current set of pixels BD_{c} that was or was not obtained using the current prediction set of pixels BP_{c} and a residual signal characteristic of the difference between the value of the current pixels of B_{c} and that of the pixels of the current prediction set of pixels BP_{c}, this residual signal being quantized by a quantization parameter QP and then coded.

The network RNC1 is trained during a training phase by presenting a plurality of associated reference sets of pixels BR₀, BR₁, etc. together with a current set of pixels B_{c}, and by changing, for example using a gradient descent algorithm, the weights of the network so as to minimize the mean squared error between the pixels of B_{c} and the result BS_{c} depending on the selection of the coding mode MC_{c} (respectively decoding mode MD_{c}).

At the end of this preliminary training phase, the network RNC1 is fixed and suitable for use in the mode determination device DMOD2.

Embodiment of a Method for Determining at Least One Coding/Decoding Mode Implemented by the Determination Device DEMOD1

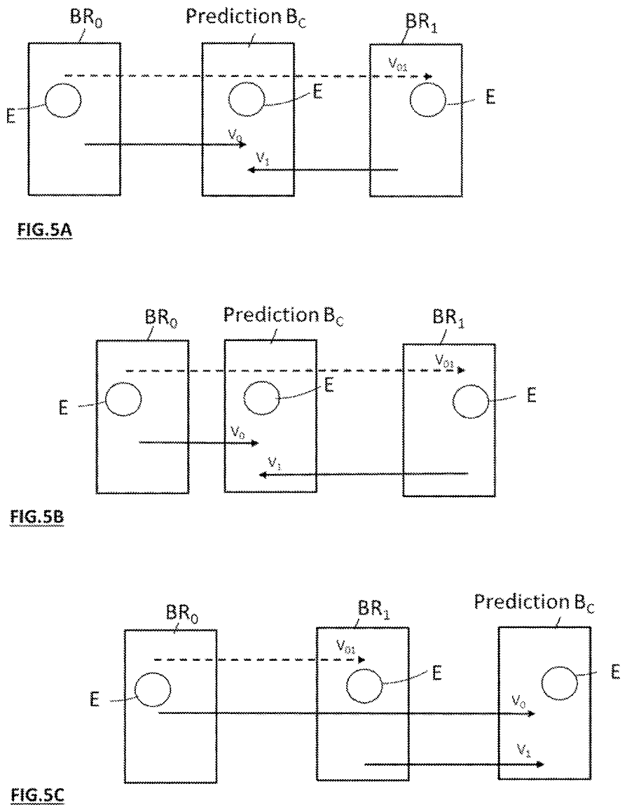

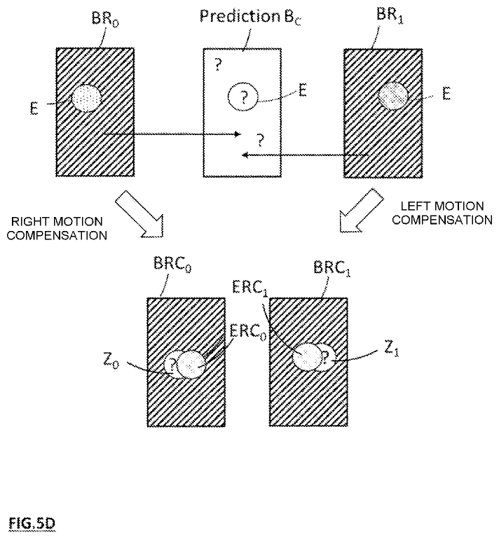

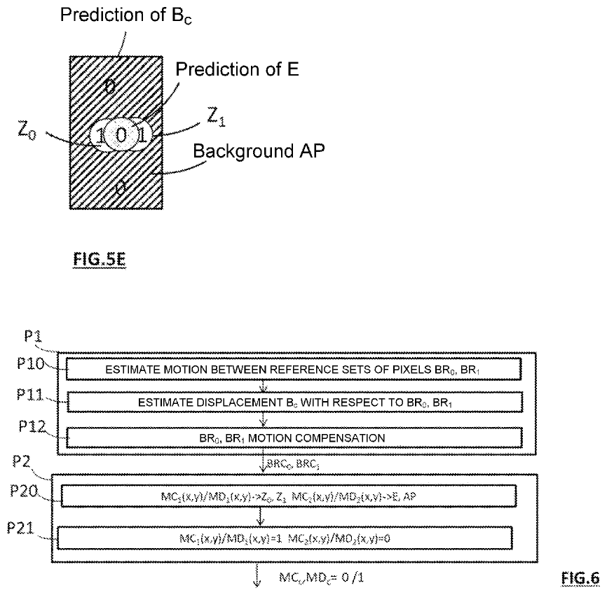

A description will now be given, with reference to FIG. 6 and FIGS. 5A to 5E, of one embodiment in which at least one coding or decoding mode for a current set of pixels is determined in the determination device DEMOD1 of FIG. 3A.

In the example shown, two reference sets of pixels BR₀ and BR₁ are taken into account to determine at least one coding or decoding mode.

To this end, as illustrated in FIG. 6, the analysis P1 of at least one reference set of pixels comprises the following:

In P10, a motion estimate between BR₀ and BR₁ is computed. Such a step is performed through conventional motion search steps, such as for example an estimation of displacement vectors.

FIGS. 5A to 5C respectively show three different exemplary displacements of a predicted version BP_{c} of the current set of pixels B_{c} with respect to two reference sets of pixels BR₀ and BR₁, which may be encountered during this step P10. In the example of FIGS. 5A to 5C, the displacement of an element E (symbolized by a circle) between the reference sets of pixels BR₀ and BR₁ is represented by a field of motion vectors. For the sake of simplification, a single vector, denoted V₀₁ and shown in dotted lines in FIGS. 5A to 5C, is shown in order to describe, in the example shown, the motion of the element E from BR₀ to BR₁ (the motion on the other portions of the image being considered to be zero). However, it goes without saying that there are as many motion vectors as there are pixels representing the reference sets of pixels BR₀ to BR₁, as for example in the case of an optical flow motion estimation. According to another example not shown in FIGS. 5A to 5C, a vector V₁₀, describing the (opposite) motion from BR₁ to BR₀, could be computed. With the vector V₀₁ or V₁₀ having been obtained in P10, P11 (FIG. 6) comprises estimating the displacement of the current set of pixels B_{c} to be predicted with respect to BR₀ and BR₁. This estimation is illustrated in FIGS. 5A to 5C, where the displacement of the element E is estimated at a time instant other than that at which BR₀ and BR₁ are located, which is the instant at which the current set of pixels B_{c} is located. Using the same conventions as for the computing of V₀₁ or V₁₀:
a single vector V₀, which describes the motion from BR₀ to the predicted position of B_{c}, is computed from the vector V₀₁,
a single vector V₁, which describes the motion from BR₁ to the predicted position of B_{c}, is computed from the vector V₀₁.

In the example of FIG. 5A, in which the current set of pixels B_{c} is located halfway in time between BR₀ and BR₁, then the displacement of the element E at the current instant is estimated as corresponding to half the displacement between BR₀ and BR₁, that is to say half the vector V₀₁ or V₁₀. Such a displacement configuration is encountered in the case where for example, adopting the same notations as in FIG. 2B, BR₀ belongs to the reference image IRᵢ₋₁ and BR₁ belongs to the reference image IRᵢ₊₁.

In the example of FIG. 5B, in which the current set of pixels B_{c} is located closer in time to BR₀ than to BR₁, then the displacement of the element E at the current instant is estimated as being shorter than half the displacement between BR₀ and BR₁. For example, if BR₀ belongs to the reference image IRᵢ₋₁ and BR₁ belongs to the reference image IRᵢ₊₂, then the displacement of the element E at the current instant is estimated as corresponding to one third of the displacement between BR₀ and BR₁, that is to say one third of the vector V₀₁ or V₁₀.

In the example of FIG. 5C, in which the current set of pixels B_{c} is located after BR₀ and then BR₁ in time, BR₀ belonging to the reference image IRᵢ₋₂ and BR₁ belonging to the reference image IRᵢ₋₂, then the displacement of the element E at the current instant is estimated as twice the displacement between BR₀ and BR₁, that is to say twice the vector V₀₁ or V₁₀.

With reference to FIGS. 6 and 5D, in P12, BR₀ and BR₁ are each motion-compensated using the vectors V₀ and V₁, in order to respectively create two predicted versions of B_{c}, denoted BRC₀ and BRC₁.

By way of illustration in FIG. 5D, it is considered that the vectors V₀ and V₁ were obtained for example in accordance with the motion configuration shown in FIG. 5A, for which the displacement of the element E at the current instant is estimated as corresponding to half the displacement between BR₀ and BR₁, that is to say half the vector V₀₁ or V₁₀.

FIG. 5D shows:
a right-motion-compensated set of pixels BRC₀, on which the interpolated position of the element E comprises a set of pixels ERC₀ resulting from the motion compensation of the element E of BR₀, by the vector V₀,
a left-motion-compensated set of pixels BRC₁, on which the interpolated position of the element E comprises a set of pixels ERC₁ resulting from the motion compensation of the element E of BR₁, by the vector V₁.

In contrast, a part Z₀ of ERC₀ and a part Z₁ of ERC₁ are undefined since they correspond to the unknown content that is located behind the element E of BR₀ and the element E of BR₁. However, as may be seen in FIG. 5D, the part Z₀ is defined in ERC₁ and the part Z₁ is defined in ERC₀.

With reference to FIG. 6 and to FIG. 5E, a description is given of the selection P2 of one of the at least two coding modes MC₁, MC₂ or decoding modes MD₁, MD₂ for each pixel of the current set of pixels B_{c}. FIG. 5E shows a predicted position of the current set of pixels B_{c}, which shows a predicted position of the element E and the undefined parts Z₀ and Z₁.

With the pixels located at the position (x,y) of Z₀ and Z₁ not being known, they are associated in P20 with a first coding mode MC₁(x,y)=Inter, respectively decoding mode MD₁(x,y)=Inter.

The pixels located at the predicted position (x,y) of the element E and at the predicted position (x,y) of the background AP (represented by hatching) are known, in the sense that these pixels are coherent with the pixels of the element E and of the background AP in each of the reference sets of pixels BR₀ and BR₁. To this end, in P20, these pixels are associated with a second coding mode MC₂(x,y)=Skip, for example, respectively decoding mode MD₂(x,y)=Skip.

In P21, the first coding mode MC₁(x,y)=Inter, respectively decoding mode MD₁(x,y)=Inter, takes an arbitrary value, for example 1, whereas the second coding mode MC₂(x,y)=Skip, respectively decoding mode MD₂(x,y)=Skip, takes an arbitrary value different from that of MC₁(x,y)/MD₁(x,y), for example 0.

At the end of step P21, a coding mode MC_{c}, respectively decoding mode MD_{c}, is determined, which takes two different values, 0 or 1, depending on the pixels under consideration in the current set of pixels B_{c}.

As a variant:
the pixels located at the position of Z₀ and Z₁ are associated in P20 with a first coding mode MC₁(x,y)=Intra, respectively decoding mode MD₁(x,y)=Intra,
the pixels located at the predicted position of the element E are associated in P20 with a second coding mode MC₂(x,y)=Inter, respectively decoding mode MD₂(x,y)=Inter,
the pixels located in the background AP are associated in P20 with a third coding mode MC₃(x,y)=Skip, respectively decoding mode MD₃(x,y)=Skip.

In P21:
the first coding mode MC₁(x,y)=Intra, respectively decoding mode MD₁(x,y)=Intra, takes an arbitrary value, for example 1,
the second coding mode MC₂(x,y)=Inter, respectively decoding mode MD₂(x,y)=Inter, takes an arbitrary value different from that of MC₁(x,y)/MD₁(x,y), for example 0,
the third coding mode MC₃(x,y)=Skip, respectively decoding mode MD₃(x,y)=Skip, takes an arbitrary value different from that of MC₁(x,y)/MD₁(x,y) and MC₂(x,y)/MD₂(x,y), for example 2.

At the end of step P21, a coding mode MC_{c}, respectively decoding mode MD_{c}, is determined, which takes three different values, 0, 1 or 2, depending on the pixels under consideration in the current set of pixels B_{c}.

Image Coding Method

General Principle

A description is given below, with reference to FIG. 7, of an image coding method implementing the determination of at least one coding mode MC_{c} that was described with reference to FIG. 1.

Such a coding method comprises the following:

In C1, the determination of at least one coding mode MC_{c}, in its steps P1 to P2 illustrated in FIG. 1, is implemented, generating a current coding mode MC_{c} for each of the N pixels of the current set of pixels B_{c}.

In C2, a test is carried out to determine which coding mode has been associated with which subset of pixels SE₁, SE₂, SE₃, etc. of B_{c}.

In C20, a test is carried out to determine whether the coding mode MC_{c}=Intra was determined for coding B_{c}.

If the response is positive (Y in FIG. 7), in C30, a subset of pixels SE₁ is coded in Intra mode. At the end of this step, a coded subset of residual pixels SER₁^{cod} is generated, conventionally accompanied by the index of the Intra mode used.

If the response is negative (N in FIG. 7), in C21, a test is carried out to determine whether the coding mode MC_{c}=Inter was determined for coding B_{c}.

If the response is positive (Y in FIG. 7), in C31, a subset of pixels SE₂ is coded in Inter mode. At the end of this step, a coded subset of residual pixels SER₂^{cod} is generated, along with a motion vector V₂^{cod} that was used during this coding in Inter mode.

If the response is negative (N in FIG. 7), in C22, a test is carried out to determine whether the coding mode MC_{c}=Skip was determined for coding B_{c}.

If the response is positive (Y in FIG. 7), in C32, a subset of pixels SE₃ is coded in Skip mode. At the end of this step, a coded motion vector V₃^{cod} is generated. No residual is computed and coded for this mode. In a first embodiment, V₃^{cod}=V₂^{cod}. In a second embodiment, V₃^{cod}≠V₂^{cod}.

If the response is negative (N in FIG. 7), it is determined whether another coding mode MC_{c} was determined for coding B_{c}, and so on until all of the pixels of B_{c} are assigned a coding mode MC_{c}.

In C4, the coded motion vectors V₂^{cod} and V₃^{cod}, or only V₃^{cod} in the case where V₃^{cod}=V₂^{cod}, along with the data from the coded subsets of residual pixels SER₁^{cod} and SER₂^{cod}, are written to a transport stream F able to be transmitted to a decoder, which will be described later in the description. These written data correspond to the coded current set of pixels B_{c}, denoted B_{c}^{cod}.

In accordance with the invention, the one or more coding modes as such are advantageously neither coded nor transmitted to the decoder.

The subset of pixels SE₁ (respectively SE₂, SE₃) may correspond to at least one pixel of B_{c}, to at least one region of pixels of B_{c}, or to B_{c} in its entirety. The Intra, Inter and/or Skip coding operations that are implemented are conventional and compliant with AVC, HEVC, VVC coding or the like.

The coding that has just been described may of course apply to B_{c} a single coding mode from among the three mentioned, or only two different coding modes, or even three or more different coding modes.

Encoder Exemplary Implementations

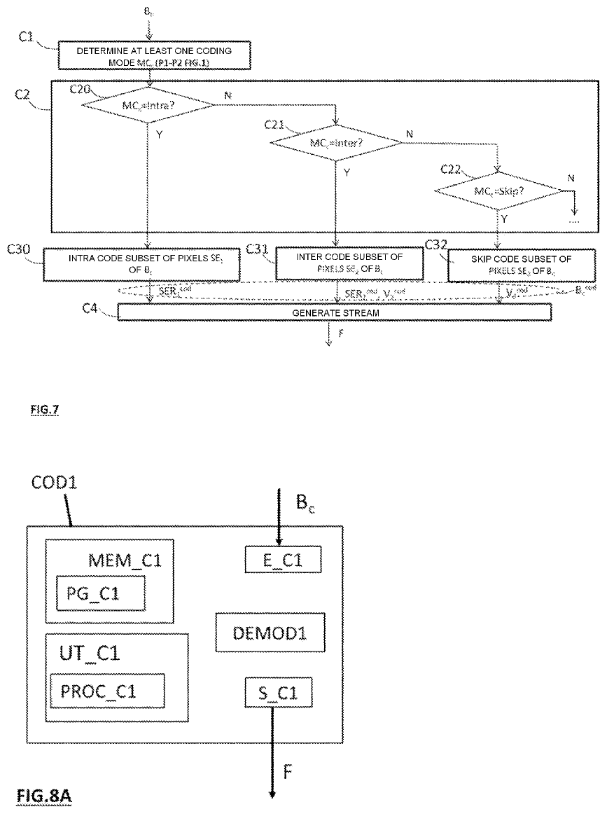

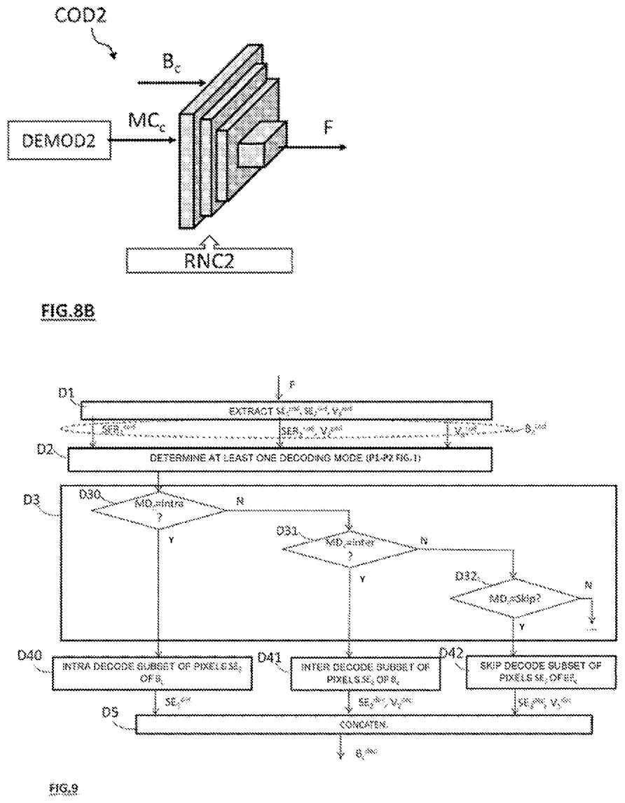

FIG. 8A shows an encoder COD1 suitable for implementing the coding method illustrated in FIG. 7, according to a first embodiment of the invention. The encoder COD1 comprises the determination device DEMOD1.

According to this first embodiment, the actions performed by the coding method are implemented by computer program instructions. To that end, the coding device COD1 has the conventional architecture of a computer and comprises in particular a memory MEM_C1, a processing unit UT_C1, equipped for example with a processor PROC_C1, and driven by the computer program PG_C1 stored in memory MEM_C1. The computer program PG_C1 comprises instructions for implementing the actions of the coding method as described above when the program is executed by the processor PROC_C1.

On initialization, the code instructions of the computer program PG_C1 are for example loaded into a RAM memory (not shown) before being executed by the processor PROC_C1. The processor PROC_C1 of the processing unit UT_C1 implements in particular the actions of the coding method described above, according to the instructions of the computer program PG_C1.

The encoder COD1 receives, at input E C1, a current set of pixels B_{c} and delivers, at output S_C1, the transport stream F, which is transmitted to a decoder using a suitable communication interface (not shown).

FIG. 8B shows an encoder COD2 suitable for implementing the coding method illustrated in FIG. 7, according to a second embodiment of the invention. The encoder COD2 comprises the abovementioned determination device DEMOD2 followed by a convolutional neural network RNC2 that codes the current set of pixels B_{c} in conjunction with the one and/or more coding modes MC_{c} determined by the determination device DEMOD2. Such a network RNC2 is for example of the type described in the document: Ladune “Optical Flow and Mode Selection for Learning-based Video Coding”, IEEE MMSP 2020.

Image Decoding Method

General Principle

A description is given below, with reference to FIG. 9, of an image decoding method implementing the determination of at least one decoding mode MD_{c} as described with reference to FIG. 1.

Such a decoding method implements image decoding corresponding to the image coding of FIG. 7. In particular, apart from the determination of said at least one decoding mode MD_{c}, the decoding method implements conventional decoding steps that are compliant with AVC, HEVC, VVC decoding or the like.

The decoding method comprises the following: In D1, coded data associated with B_{c} are extracted, in a conventional manner, from the received transport stream F, which data are, in the example shown:
the coded subset of residual pixels SER₁^{cod} and its Intra mode index, if it is the Intra coding C30 of FIG. 7 that was implemented,
the coded subset of residual pixels SER₂^{cod} and possibly the coded motion vector V₂^{cod} in the case where V₂^{cod}≠V₃^{cod}, if it is the Inter coding C31 of FIG. 7 that was implemented,
the coded motion vector V₃^{cod}, if it is the Skip coding C32 of FIG. 7 that was implemented.

These data correspond to the coded current set of pixels B_{c}^{cod}.

In D2, the determination of at least one decoding mode MD_{c}, in its steps P1 to P2 illustrated in FIG. 1, is implemented, generating a current decoding mode MD_{c} for each of the N pixels of the coded current set of pixels B_{c}^{cod}.

In D3, a test is carried out to determine which decoding mode has been associated with which coded subset of pixels SE₁^{cod}, SE₂^{cod}, SE₃^{cod}, etc. of B_{c}.

In D30, a test is carried out to determine whether the decoding mode MD_{c}=Intra was determined for decoding B_{c}^{cod}.

If the response is positive (Y in FIG. 9), in D40, a subset of pixels SE₁ is decoded in Intra mode. At the end of this step, a decoded subset of pixels SE₁^{dec} is generated. If the response is negative (N in FIG. 9), in D31, a test is carried out to determine whether the decoding mode MD_{c}=Inter was determined for decoding B_{c}^{cod}. If the response is positive (Y in FIG. 9), in D41, a subset of pixels SE₂ is decoded in Inter mode using, if V₂^{cod}·V₃^{cod}, a motion vector V₂^{dec} resulting from the decoding of V₂^{cod} and, if V₂^{cod}=V₃^{cod}, using a motion vector V₃^{dec} resulting from the decoding of V₃^{cod}. At the end of this step, a decoded subset of pixels SE₂^{dec} is generated.

If the response is negative (N in FIG. 9), in D32, a test is carried out to determine whether the decoding mode MD_{c}=Skip was determined for decoding B_{c}^{cod}. If the response is positive (Y in FIG. 9), in D42, a subset of pixels SE₃ is decoded in Skip mode. At the end of this step, a decoded subset of pixels SE₃^{dec} is generated using the decoded motion vector V₃^{dec}.

If the response is negative (N in FIG. 9), it is determined whether another decoding mode MD_{c} was determined for decoding B_{c}, and so on until all of the coded pixels of B_{c} are assigned a decoding mode MD_{c}.

In D5, the decoded subsets of pixels SE₁^{dec}, SE₂^{dec}, SE₃^{dec} are concatenated. At the end of step D5, a reconstructed current set of pixels B_{c}^{dec} is generated.

In accordance with the invention, the one or more decoding modes as such are advantageously determined autonomously at the decoder.

The Intra, Inter and/or Skip decoding operations that are implemented are conventional and compliant with AVC, HEVC, VVC decoding or the like.

The decoding that has just been described may of course apply for a coded set of pixels under consideration, here B_{c}^{cod}, a single decoding mode from among the three mentioned, or only two different decoding modes, or even three or more different decoding modes. The application of one or more decoding modes may vary from one coded set of pixels under consideration to another.

In a manner known per se, the reconstructed current set of pixels B_{c}^{dec} may possibly undergo filtering by a loop filter, which is well known to those skilled in the art.

Decoder Exemplary Implementations

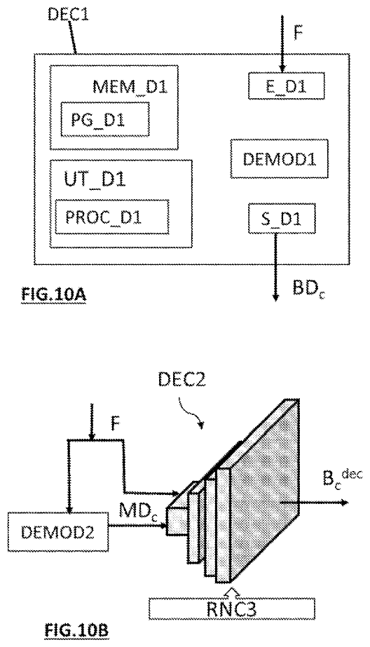

FIG. 10A shows a decoder DEC1 suitable for implementing the decoding method illustrated in FIG. 9, according to a first embodiment of the invention. The decoder DEC1 comprises the determination device DEMOD1.

According to this first embodiment, the actions performed by the decoding method are implemented by computer program instructions. To that end, the decoder DEC1 has the conventional architecture of a computer and comprises in particular a memory MEM_D1, a processing unit UT_D1, equipped for example with a processor PROC_D1, and driven by the computer program PG_D1 stored in memory MEM_D1. The computer program PG_D1 comprises instructions for implementing the actions of the decoding method as described above when the program is executed by the processor PROC_D1.

On initialization, the code instructions of the computer program PG_D1 are for example loaded into a RAM memory (not shown) before being executed by the processor PROC_D1. The processor PROC_D1 of the processing unit UT_D1 implements in particular the actions of the decoding method described above in connection with FIG. 9, according to the instructions of the computer program PG_D1.

The decoder DEC1 receives, at input E D1, the transport stream F transmitted by the encoder COD1 of FIG. 8A and delivers, at output S D1, the current decoded set of pixels B_{c}^{dec}.

FIG. 10B shows a decoder DEC2 suitable for implementing the decoding method illustrated in FIG. 9, according to a second embodiment of the invention. The decoder DEC2 comprises the abovementioned determination device DEMOD2 followed by a convolutional neural network RNC3 that for example decodes the current coded set of pixels B_{c}^{cod} in conjunction with the decoding mode MD_{c} generated by the determination device DEMOD2. Such a network RNC3 is for example of the type described in the document: Ladune “Optical Flow and Mode Selection for Learning-based Video Coding”, IEEE MMSP 2020.

Variant of the Method for Determining at Least One Coding or Decoding Mode

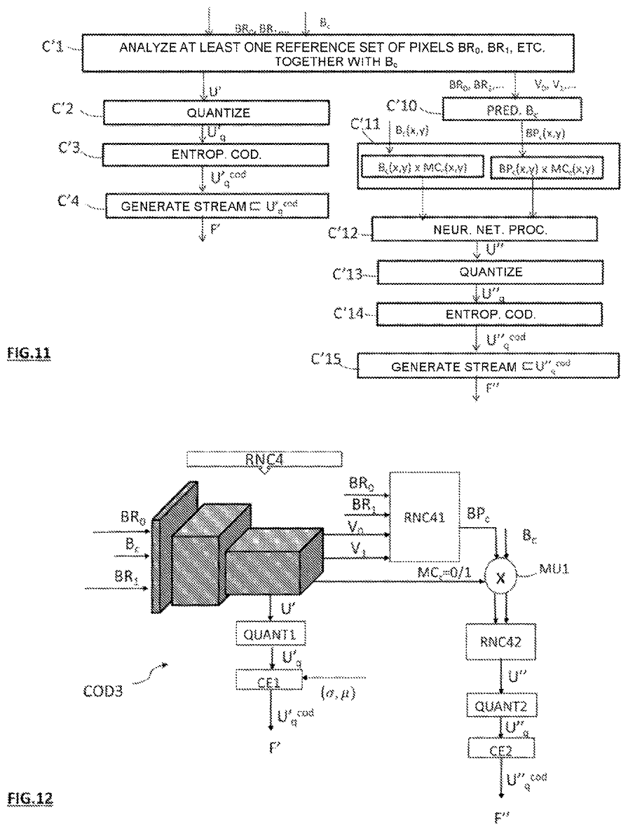

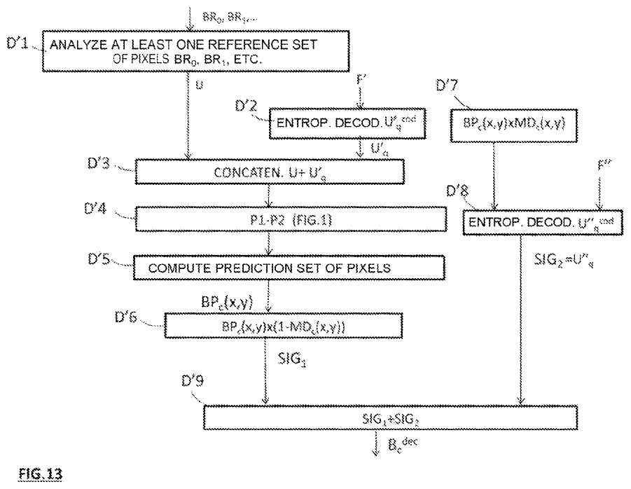

A description will now be given, with reference to FIGS. 11 and 12, of one variant of the method for determining at least one coding mode, as illustrated in FIG. 1. Such a variant is implemented in an encoder COD3.

Such a variant aims to improve the determination of at least one coding or decoding mode of FIG. 1 when the precision/quality of the coding or decoding mode that is obtained is not satisfactory.

To this end, on the encoder side, as illustrated in FIG. 11, in C′1, said at least one reference set of pixels BR₀ is analyzed together with the current set of pixels B_{c}. For example, two reference sets of pixels BR₀ and BR₁ are analyzed together with B. In the example shown, BR₀ is located before B_{c} in time and BR₁ is located after B_{c} in time.

As shown in FIG. 12, the analysis C′1 is implemented using a convolutional neural network RNC4 that creates, from the two reference sets of pixels BR₀ and BR₁ and from the current set of pixels B_{c}, a transformation through a certain number of layers, such as for example layers implementing convolutional filters (CNN) followed by layers implementing non-linearities and decimations, as described in the document: Ladune “Optical Flow and Mode Selection for Learning-based Video Coding”, IEEE MMSP 2020.

At the end of step C′1, a set of latent variables is obtained in the form of a signal U′. The signal U′ is quantized in C′2 by a quantizer QUANT1, for example a uniform or vector quantizer controlled by a quantization parameter. A quantized signal U′_{q} is then obtained.

In C′3, the quantized signal U′_{q} is coded using an entropy encoder CE1, for example of arithmetic type, with a determined statistic. This statistic is for example parameterized by probabilities of statistics, for example by modeling the variance and the mean of a Laplacian law (σ, μ), or else by considering hyperpriors as in the publication: “Variational image compression with a scale hyperprior” by Ballé, which was presented at the ICLR 2018 conference. A coded quantized signal U′_{q}^{cod} is then obtained.

In C′4, the coded quantized signal U′_{q}^{cod} is written to a transport stream F′, which is transmitted to a decoder DEC3, illustrated in FIG. 14.

In the example shown, the data contained in the coded quantized signal U′_{q}^{cod} are representative of information associated with a coding mode MC_{c} as determined as described above with reference to FIG. 1. In the embodiment described here, MC_{c} is set to 0 to indicate use of the Skip coding mode and is set to 1 to indicate use of the Inter coding mode.

To this end, the network RNC4 has been trained to offer a continuum of weighting between the values 0 and 1 of MC_{c}.

During coding, the encoder COD3, in C′10, predicts the set of pixels B_{c} to be coded by carrying out motion compensation, which uses reference sets of pixels BR₀, BR₁ and motion vectors V₀, V₁. The vectors V₀, V₁ may be derived from the “MOFNEt” neural network as described in the Ladune publication “Optical Flow and Mode Selection for Learning-based Video Coding”, IEEE MMSP 2020. This gives a prediction of B_{c}, called BP_{c}(x,y). The prediction C′10 is implemented using a neural network RNC41.

In C′11, B_{c} and BP_{c}(x,y) are multiplied pixel by pixel by the mode value M_{c}(x,y) between 0 and 1, using a multiplier MU1 illustrated in FIG. 12. At the end of this operation, what is obtained is a signal U″ representative of these two weighted inputs after passage thereof, in C′12, through a neural network RNC42. In C′13, the signal U″ is quantized by a quantizer QUANT2, generating a quantized signal U″_{q}. The latter is then coded in C′14 by an entropy encoder CE2, generating a coded quantized signal U″_{q}^{cod}. Steps C′13 and C′14 are implemented in an encoder based on neural networks in accordance with the abovementioned reference, in order to generate the coded quantized signal U″_{q}^{cod}.

In C′15, the coded quantized signal U″_{q}^{cod} is written to a transport stream F″, which is transmitted to a decoder DEC3, illustrated in FIG. 14.

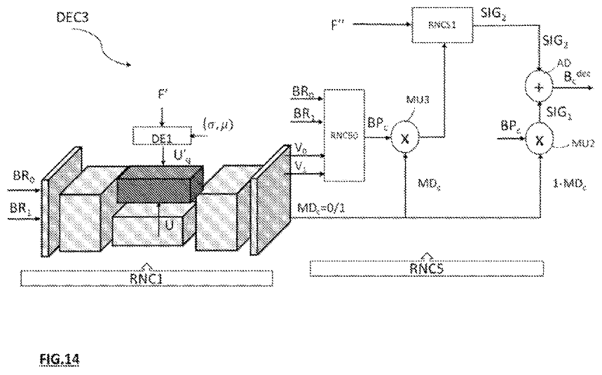

A description will now be given, with reference to FIGS. 13 and 14, of one variant of the method for determining a decoding mode illustrated in FIG. 1, as implemented in a decoder DEC3.

To this end, on the decoder side, as illustrated in FIG. 13, in D′1, at least one reference set of pixels BR₀ is analyzed, two sets of reference pixels BR₀ and BR₁ in the example shown. Such analysis is identical to that performed in step P1 of FIG. 1, using the neural network RNC1. At the end of this step, a latent space U representative of V₀, V₁, etc., MD_{c}, etc. is obtained.

Following the reception of the stream F′, in D′2, entropy decoding is carried out on the coded quantized signal U′_{q}^{cod} using an entropy decoder DE1 corresponding to the entropy encoder CE1 of FIG. 12, with the same determined statistic, such as the modeling of the variance and of the mean of a Laplacian law (σ, μ). A decoded quantized signal U′_{q} is obtained at the end of this operation.

In D′3, the decoded quantized signal U′_{q} is concatenated with the latent space U obtained by the neural network RNC1 of FIG. 14 and representative of the analysis of only the reference sets of pixels BR₀ and BR₁.

The neural network RNC1 then processes, in D′4, this concatenation through various layers, in the same way as in step P2 of FIG. 1, in order to estimate the motion information V₀, V₁, etc., along with the values in the 0 to 1 continuum of the decoding mode MD_{c} to be applied to the coded current set of pixels B_{c}^{cod} to be reconstructed. In the embodiment described here and in accordance with the coding mode MC_{c} determined and used in the coding method of FIG. 11, MD_{c} is set to 0 to indicate use of the Skip decoding mode and is set to 1 to indicate use of the Inter decoding mode.

A neural network RNC5 of the abovementioned type receives this information at input so as to reconstruct the current set of pixels, in order to generate a reconstructed set of pixels B_{c}^{dec}. Such a network RNC5 is for example of the type described in the document: Ladune “Optical Flow and Mode Selection for Learning-based Video Coding”, IEEE MMSP 2020. To this end, the neural network RNC5 comprises a neural network RNC50 that computes, in D'S, a current prediction set of pixels BP_{c}(x,y) from the motion information V₀, V₁, etc. delivered by the network RNC1 and from the reference sets of pixels BR₀, BR₁, etc.

In D′6, BP_{c}(x,y) is multiplied pixel by pixel by (1-MD_{c}(x,y)) in a multiplier MU2 illustrated in FIG. 14. At the end of this operation, what is obtained is a signal SIG₁ that is representative of the pixels of B_{c} that were decoded in the decoding mode MD_{c}=Skip.

In D′7, BP_{c}(x,y) is multiplied pixel by pixel by MD_{c}(x,y) in a multiplier MU3 illustrated in FIG. 14.

With continuing reference to FIGS. 13 and 14, the neural network RNC5 also comprises a neural network RNC51 that, following reception of the flow F″ generated by the encoder COD3 in C′14 (cf. FIGS. 11 and 12), entropically decodes, in D′8, the coded quantized signal U″_{q}^{cod} that corresponds to the pixel residual resulting from the prediction weighted by the coding mode MC_{c}, as implemented by the encoder COD3 of FIG. 12. Such decoding uses the result of the multiplication implemented in D′7. At the end of step D′8, what is generated is a signal SIG₂ that is representative of the pixels of B_{c} that were decoded in the decoding mode MD_{c}=Inter.

In D′9, the signals SIG₁ and SIG₂ are added in an adder AD, generating the reconstructed current set of pixels B_{c}^{dec} that contains the reconstructed pixels of B_{c} in their entirety.

Thus, if MD_{c}(x,y) is close to zero, then the prediction BP_{c}(x,y) will be predominant. On the contrary, if MD_{c}(x,y) is close to 1, then the reconstructed signal B_{c}^{dec} will be formed using the difference signal SIG₂ conveyed in addition to BP_{c}(x,y).

In the embodiments that have been disclosed above with reference to FIG. 3A et seq., two reference sets of pixels BR₀, BR₁ are used in the method for determining at least one coding mode.

These embodiments may be extended to three or more reference sets of pixels. To this end, the neural network RNC1 described with reference to FIG. 3B will be trained from three reference sets of pixels BR₀, BR₁, BR₂ or more to obtain the coding mode MC_{c} or decoding mode MD_{c}.

1. A determination method implemented by a determination device and comprising:
determining at least one of a coding mode, or respectively a decoding mode, from among at least two coding modes, or respectively at least two decoding modes, for coding, or respectively decoding, at least one current set of pixels, wherein said at least one coding mode, or respectively said at least one decoding mode, is determined based on an analysis of at least one reference set of pixels belonging to an already decoded reference image; and
outputting the at least one coding mode, or respectively the at least one decoding mode.

2. The determination method as claimed in claim 1, wherein the analysis of at least one reference set of pixels implements motion estimation or filtering of said at least one reference set of pixels.

3. The determination method as claimed in claim 2, wherein the motion estimation comprises optical flow motion estimation.

4. The determination method as claimed in claim 1, wherein a single mode from among said at least two modes is determined for at least one pixel of the current set of pixels, and a single mode from among said at least two modes is determined for at least one other pixel of the current set of pixels, the determination of one or the other mode varying from said at least one pixel to at least one other pixel of said set.

5. The determination method as claimed in claim 1, wherein the at least two modes are determined in combination for at least one pixel of the current set of pixels.

6. The determination method as claimed in claim 1, wherein the determination of said at least one mode is modified by a modification parameter that results from joint analysis of the current set of pixels and of at least one reference set of pixels.

7. A determination device for determining at least one coding mode, or respectively at least one decoding mode, comprising:
at least one a processor; and
at least one processor readable medium comprising instructions stored thereon which when executed by the at least one processor configures the determination device to determine the at least one coding mode, or respectively the at least one decoding mode, from among at least two coding modes, or respectively at least two decoding modes, for coding, or respectively decoding, at least one current set of pixels, wherein said at least one coding mode, or respectively said at least one decoding mode, is determined based on an analysis of at least one reference set of pixels belonging to an already decoded reference image.

8. The determination device as claimed in claim 7, wherein the at instructions configure the determination device to execute a neural network.

9. (canceled)

10. A non-transitory computer-readable information medium comprising instructions of a computer program stored thereon which when executed by at least one processor of a determination device configure the determination device to execute a method comprising:
determining at least one coding mode, or respectively at least one a decoding mode, from among at least two coding modes, or respectively at least two decoding modes, for coding, or respectively decoding, at least one current set of pixels, wherein said at least one coding mode, or respectively said at least one decoding mode, is determined based on an analysis of at least one reference set of pixels belonging to an already decoded reference image; and
outputting the at least one coding mode, or respectively the at least one decoding mode.

11. A method implemented by a coding device and comprising:
determining at least one coding mode from among at least two coding modes based on an analysis of at least one reference set of pixels belonging to an already decoded reference image; and
coding at least one current set of pixels based on the determination of the at least one coding mode.

12. A coding device for coding at least one current set of pixels, comprising:
at least one a processor; and
at least one processor readable medium comprising instructions stored thereon which when executed by the at least one processor configures the coding device to code at least one current set of pixels by:
determining at least one coding mode from among at least two coding modes based on an analysis of at least one reference set of pixels belonging to an already decoded reference image; and
coding the at least one current set of pixels based on the determination of the at least one coding mode.

13. A method implemented by a decoding device and comprising:
determining at least one decoding mode from among at least two decoding modes based on an analysis of at least one reference set of pixels belonging to an already decoded reference image; and
decoding at least one current set of pixels based on the determination of the at least one decoding mode.

14. A decoding device comprising:
at least one a processor; and
at least one processor readable medium comprising instructions stored thereon which when executed by the at least one processor configures the decoding device to:
determine at least one decoding mode from among at least two decoding modes based on an analysis of at least one reference set of pixels belonging to an already decoded reference image; and
decode at least one current set of pixels based on the determination of the at least one decoding mode.

15. (canceled)

16. A non-transitory computer-readable information medium comprising instructions of a computer program stored thereon which when executed by at least one processor of a coding device or a decoding device configure the coding device or the decoding device to execute a method comprising:
determining at least one coding mode, or respectively at least one decoding mode, from among at least two coding modes, or respectively at least two decoding modes, for coding, or respectively decoding, at least one current set of pixels, wherein said at least one coding mode, or respectively said at least one decoding mode, is determined based on an analysis of at least one reference set of pixels belonging to an already decoded reference image; and
coding, or respectfully decoding, the at least one current set of pixels based on the determination of the at least one coding mode, or respectfully the at least one decoding mode.
